(19) United States
(12) Patent Application Publication
(10) Pub. No.: US 2002/0163603 A1
(43) Pub. Date: Nov. 7, 2002

(54) Liquid crystal display device and method for fabricating the same

(76) Inventors: Yong Jin Cho, Seoul (KR); Hyun Kyu Lee, Seoul (KR)

Correspondence Address: MCKENNA LONG & ALDRIDGE LLP, 1900 K STREET, NW, WASHINGTON, DC, 20006, US

(21) Appl. No.: 10/028,984

(22) Filed: Dec. 28, 2001

(30) Foreign Application Priority Data
May 7, 2001 (KR) P2001-024581

(51) Int. Cl. G02F 1/136

(52) U.S. Cl. 349/43

(57) ABSTRACT

A method for fabricating a liquid crystal display (LCD) device is disclosed, in which an aperture ratio is increased by reducing an area of a drain electrode which applies an electrical signal to a pixel electrode of a pixel region. In the LCD device, a contact hole where the drain electrode of TFTs is electrically connected to the pixel electrode is formed over predetermined portions of the drain electrode and the pixel region.

This application claims the benefit of the Korean Application No. P2001-024581 filed on May 7, 2001, which is hereby incorporated by reference as if fully set forth herein.

### BACKGROUND OF THE INVENTION

1. Field of the Invention

The present invention relates to a liquid crystal display (LCD) device, and more particularly, to an LCD device and method for fabricating the same that improves an aperture ratio.

2. Discussion of the Related Art

Generally, a back light in a TFT-LCD module of a notebook monitor takes a power consumption proportion more than 60%. To reduce this power consumption, an aperture ratio has to be increased. An aperture ratio means a proportion of an area for generating an active contrast compared with an entire display area. The aperture ratio becomes an effective transparent region that acts on a real light transmittance.

Examples of factors acting on the aperture ratio include a thickness of a gate line and a data line, an interval between a pixel electrode and either a data line or a gate line, an overlap interval between a black matrix layer and a pixel electrode, a storage capacitance, and an area of a TFT, etc.

Accordingly, to realize a high aperture ratio, sizes of the aforementioned factors have to be decreased, taking into consideration the following.

That is, in the data line, an open of the data line and a mask alignment error should be considered. Sign al delay caused by a line resistance in the gate line according to a line width of the gate line should be considered. Also, in the interval between the pixel electrode and the data line, a mask alignment error, a short between two electrodes, and disinclination of a liquid crystal should be considered. In the interval between the pixel electrode and the gate line, a mask alignment error and parasitic capacitance have to be considered. Also, in the overlap interval between the black matrix layer and the pixel electrode, etching loss of the black matrix layer, attachment margin, and an alignment error of the pixel electrode should be taken into consideration. In the capacitance, a feed through and in the TFT, a recharge rate have to be considered.

Besides the aforementioned factors contributing to the aperture ratio, an area of a drain electrode electrically connected to a pixel electrode may be considered to enhance the aperture ratio. If an area of the drain electrode is small, an area of an upper black matrix covering the drain electrode is correspondingly small, thereby enhancing the aperture ratio.

Hereinafter, structures of a related art LCD device will be explained with reference to the accompanying drawings.

FIG. 1 is a structural plan view of a unit pixel according to the related art LCD device, and FIG. 2 is a sectional structural view taken along line I-I′ of FIG. 1.

As shown in FIG. 1, a plurality of gate lines 112 are arranged in a direction at constant intervals, and a plurality of data lines 111 perpendicular to the gate lines are arranged to define a pixel region of a matrix shape. Also, a TFT having source and drain electrodes 106 and 107, and a gate electrode 102 is formed at crossing points of the gate lines 112 and the data lines 111. A pixel electrode 109 is formed in each pixel region. That is, the source electrode 106 of the TFT is connected to the data lines 111, the gate electrode 102 of the TFT is connected to the gate lines 112, and the pixel electrode 109 is electrically connected to the drain electrode 107 of the TFT.

At this time, the drain electrode 107 of the TFT is extends to a predetermined region of the pixel electrode 109, and is connected to the pixel electrode 109 through a contact hole 110 formed on the drain electrode 107.

Sectional structures of the TFT and the pixel electrode of the LCD device will be explained.

That is, as shown in FIG. 2, gate lines 112 including the gate electrode 102 of the TFT are formed on an lower substrate 101. A gate insulating film 103 is deposited on an entire surface of the substrate including the gate electrode 102 and the gate lines.

Also, a semiconductor layer 104 is formed at regions where data lines and a TFT will be formed, on the gate insulating film 103. Data lines 111 provided with the source electrode 106 of a TFT made of a conductive metal is formed, and the drain electrode 107 of the TFT is formed opposite the source electrode 106. An ohmic contact layer 105 is formed among the semiconductor layer, the source electrode 106, and the drain electrode 107. A passivation film 108 of SiNx is formed on an entire surface of the substrate including the source and drain electrodes 106 and 107 so that a contact hole 110 is formed above the drain electrode 107. A pixel electrode 109 such as Indium Tin Oxide (ITO) is formed in a pixel region on the passivation film so as to be electrically connected to the drain electrode 107 through the contact hole.

Although not shown, a black matrix layer is formed at a part corresponding to the TFT, the gate lines, and the data lines to prevent light from being transmitted to regions other than the pixel region of the upper insulating substrate. Also, a color filter layer is formed on the upper insulating substrate corresponding to the pixel region.

However, the aforementioned related art LCD device has the following problems.

That is, since the drain electrode of the TFT electrically connected to the pixel electrode is formed in a shape protruded toward the pixel region, an area of the black matrix layer formed on the upper substrate has to be increased to prevent light from being transmitted to the TFT of the lower substrate. In this case, an aperture ration of the LCD device is relatively decreased.

### SUMMARY OF THE INVENTION

Accordingly, the present invention is directed to an LCD device and a method for fabricating the same that substantially obviates one or more problems due to limitations and disadvantages of the related art.

An advantage of the present invention is to provide an LCD device and a method for fabricating the same which improves an aperture ratio by changing a shape of the drain electrode and then by making the drain electrode not be extended to the pixel electrode.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, an LCD device according to the present invention includes gate lines and data lines crossing to each other, and TFTs formed at the crossing points of the gate lines and the data lines.

A contact hole which electrically connects the drain electrode of the TFTs with the pixel electrode of the pixel region is formed over predetermined portions of the drain electrode and the pixel region.

In another aspect of the present invention, the LCD according to the present invention includes TFTs provided with gate lines, data lines, a gate electrode, and source and drain electrodes, wherein the gate lines are arranged to cross data lines on a substrate to define a pixel region, the TFTs are formed at crossing points of the gate lines and the data lines; a contact hole formed over the drain electrode and the pixel region; and a pixel electrode formed in the pixel region to be connected to the drain electrode over the contact hole.

Herein, the contact hole is formed through an edge part of the drain electrode and the pixel region adjacent to the edge part.

The TFT includes a gate electrode formed on a substrate; a gate insulating film formed on the entire surface including the gate electrode; a semiconductor layer formed on the gate insulating film above the gate electrode; source and drain electrodes formed at both sides of the semiconductor layer; and a passivation film formed on the entire surface of the substrate including the source/drain electrodes.

In another aspect of the present invention, a method for fabricating the LCD device includes the steps of forming TFTs provided with a gate electrode, source/drain electrodes on an insulating substrate; forming a passivation film on the entire surface of the substrate including the TFTs; forming a contact hole over predetermined portions of the drain electrode and a pixel region adjacent to the drain electrode; and forming a pixel electrode in the pixel region so that the pixel electrode is electrically connected to the drain electrode through the contact hole.

Herein, the contact hole is formed by selectively removing the passivation film on an edge part of the drain electrode and the pixel region adjacent to the edge part of the drain electrode.

The step of forming the TFTs includes the steps of forming a gate electrode on a substrate; forming a gate insulating film on the entire surface of the substrate including the gate electrode; forming a semiconductor layer at a predetermined portion on the gate insulating film; and respectively forming source and drain electrodes at both sides of the semiconductor layer.

The contact hole is formed by selectively removing the passivation film and the gate insulating film on the edge part of the drain electrode and the pixel region adjacent to the edge part of the drain electrode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a structural plan view of a unit pixel according to the related art LCD device;

FIG. 2 illustrates a structural sectional view taken along line I-I′ of FIG. 1;

FIG. 3 illustrate a structural plan view of a unit pixel of an LCD device according to the present invention;

FIG. 4 illustrates a structural sectional view taken along line II-II′ of FIG. 3;

FIGS. 5A to 5C illustrate sectional views of an LCD device according to the present invention;

FIG. 6 illustrates a plan view of a unit pixel showing a part to which light is not transmitted at the time of attaching an upper substrate to a lower substrate of a related art LCD device; and

FIG. 7 illustrates a plan view of a unit pixel showing a part to which light is not transmitted at the time of attaching an upper substrate to a lower substrate of an LCD device according to the present invention.

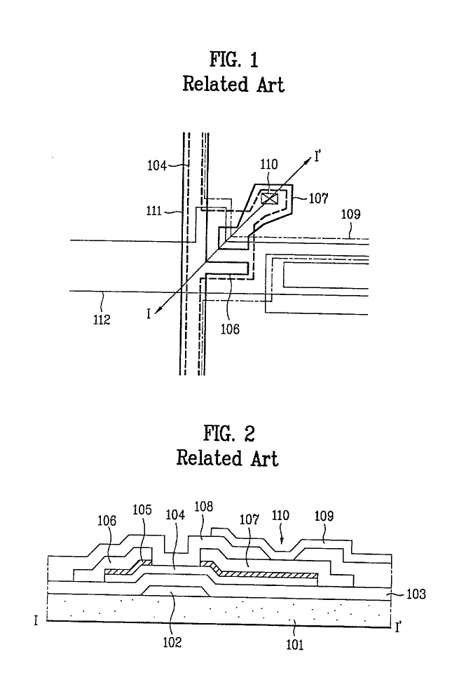

### DETAILED DESCRIPTION OF THE ILLUSTRATED EMBODIMENTS

Reference will now be made in detail to embodiments of the present invention, examples of which are illustrated in the accompanying drawings. Wherever possible, similar reference numbers will be used throughout the drawings to refer to the same or like parts.

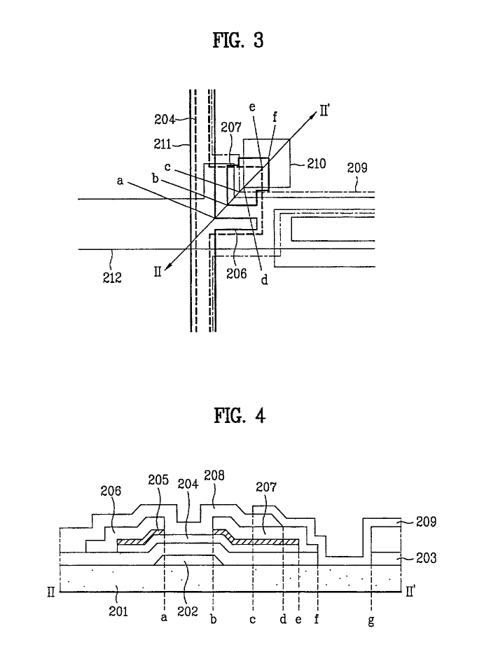

FIG. 3 illustrates a structural plan view of a unit pixel of an LCD according to the present invention, and FIG. 4 illustrates a structural sectional view taken along line II-II′ of FIG. 3.

As shown in FIG. 3, a plurality of gate lines 212 are arranged in a first direction with constant intervals between the gate lines 212, and a plurality of data lines 211 are arranged in a second direction, e.g. substantially perpendicular to the gate lines 212, to define a plurality of pixel regions in a matrix arrangement. Also, thin film transistors (TFTs) having source and drain electrodes 206, 207, and a gate electrode 202 are formed at a crossing point of the gate lines 212 and the data lines 211. At this time, a pixel electrode 209 is formed in each pixel region. That is, the source electrode 206 of the TFT is connected to the data lines 211, the gate electrode 202 of the TFT is connected to the gate lines 212, and the pixel electrode 209 is electrically connected to the drain electrode 207 of the TFT.

At this time, the drain electrode 207 of the TFTs is not extended to a predetermined portion of the pixel electrode 209. Also, a contact hole 210 is formed over predetermined portions of the drain electrode 207 and the pixel region so that the pixel electrode 209 is connected to the drain electrode 207 through the contact hole 210.

Sectional structures of the TFT and the pixel electrode of the LCD device according to the present invention will be explained in detail.

That is, as shown in FIG. 4, the gate lines 212 including the gate electrode 202 of the TFT are formed on a lower insulating substrate 201. Also, the gate insulating film 203 is deposited on an entire surface of the substrate including the gate electrode 202 and the gate lines 212.

Also, a semiconductor layer 204 is formed on the gate insulating film 203 where the data lines will be formed and on the gate electrode 202 where the TFT will be formed. Then, data lines 211 provided with the source electrode 206 of the TFT of a conductive metal and the drain electrode 207 of the TFT are formed on the semiconductor layer 204. At this time, the drain electrode 207 is formed at an opposite side of the TFT to the source electrode 206. An ohmic contact layer 205 is formed between the semiconductor layer 204 and the source and drain electrodes 206 and 207. Also, a passivation film 208 of SiNx material is formed on an entire surface of the substrate including the source and drain electrodes 206 and 207. The drain electrode 207 is formed not to be extended to a pixel region. Also, a contact hole 210 for connecting the drain electrode 207 to the pixel electrode 209 in the passivation film 208 is formed over a side of the drain electrode 207 and a pixel region. Then, a pixel electrode 209 such as Indium Tin Oxide (ITO) is formed to be electrically connected to the drain electrode 107 through the contact hole 210 in a pixel.

Herein, the contact hole 210 is formed by removing the passivation film 208 and the gate insulating film 203 so that a part of the drain electrode is exposed and an insulating substrate 201 of a pixel region adjacent to the drain electrode 207 is exposed. The semiconductor layer 204 may be formed as an island shape only in a region where TFT will be formed.

That is, whereas in a related art LCD device, a contact hole is formed above a drain electrode for being connected to a pixel electrode, in the present invention, the passivation film 208 is removed and formed by forming the drain electrode shortly so that the edge part of the drain electrode 207 and the insulating substrate 201 of the pixel region adjacent to the drain electrode 207 are exposed through the contact hole 210. Accordingly, the exposed parts by the contact hole 210 are an edge part of the drain electrode 207 and a surface part of the insulating substrate of the pixel region.

Although not shown, a black matrix layer is formed at parts corresponding to the TFTs, the gate lines, and the data lines so that light is not transmitted to regions other than the pixel region. Also, a color filter layer is formed on an upper insulating substrate corresponding to the pixel region. A liquid crystal is injected between the upper and lower substrates after attaching the upper and lower substrates to each other with constant intervals.

In the LCD device according to the present invention compared to the related art, the position of the contact hole is not changed and an area for forming the drain electrode is reduced, thereby improving an aperture ratio.

A method for fabricating the LCD device according to the present invention will be explained.

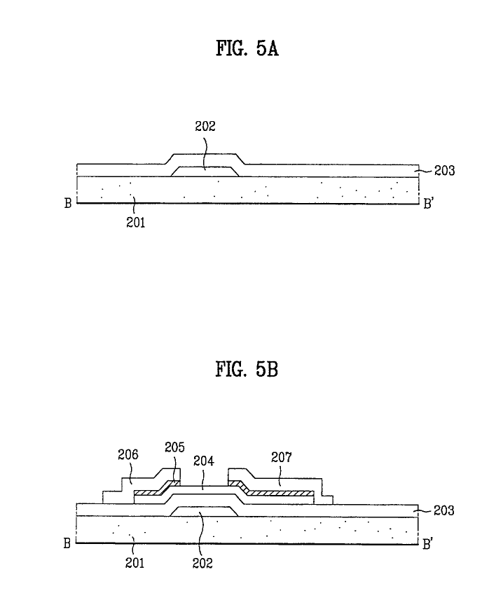

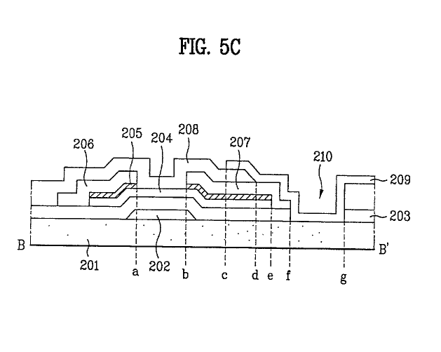

FIGS. 5A to 5C are sectional views showing method for fabricating the LCD device according to the present invention.

As shown in FIG. 5A, a conductive metal such as AINd or Al is deposited by using a sputtering method on the lower insulating substrate 201. Then, the conductive metal is patterned by a photo etching process, thereby forming the gate electrode 202 and the gate lines 212. Subsequently, an insulating material such as SiNx is deposited by a chemical vapor deposition (CVD) method on an entire surface of the substrate including the gate electrode 202 and the gate lines 212, thereby forming the gate insulating film 203.

Then, as shown in FIG. 5B, a-Si:H and doped n+ a-Si:H are sequentially deposited on the gate insulating film 203 and patterned, thereby forming the semiconductor layer 204 of the TFT and the ohmic contact layer 205. Also, low resistance metals such as Cr and Mo are deposited by using a sputtering method and patterned, thereby forming source and drain electrodes 206 and 207, and the data lines (not shown in FIG. 5). At this time, the ohmic contact layer 205 between the source electrode 206 and the drain electrode 307 is removed.

As shown in FIG. 5C, an insulating material such as SiNx is deposited on an entire surface of the substrate including the source and drain electrodes 206 and 207, thereby forming the passivation film 208. Then, the edge part of the drain electrode 207, the passivation film 208 of the pixel region where the pixel electrode will be formed, and the gate insulating film 203 are selectively removed, thereby forming the contact hole 210.

Then, Indium Tin Oxide (ITO) is deposited on an entire surface by a sputtering method and patterned so that the pixel electrode 209 is formed in the pixel region to be electrically connected to the drain electrode 207 through the contact hole 210.

Subsequently, although not shown, the lower substrate where the gate lines, data lines, TFTs, and the pixel electrode are formed and the upper substrate where the black matrix layer, color filter layer, and a common electrode are formed are attached to each other with a uniform distance therebetween. Then, a liquid crystal is injected between the upper and lower substrates, thereby fabricating the LCD device according to the present invention.

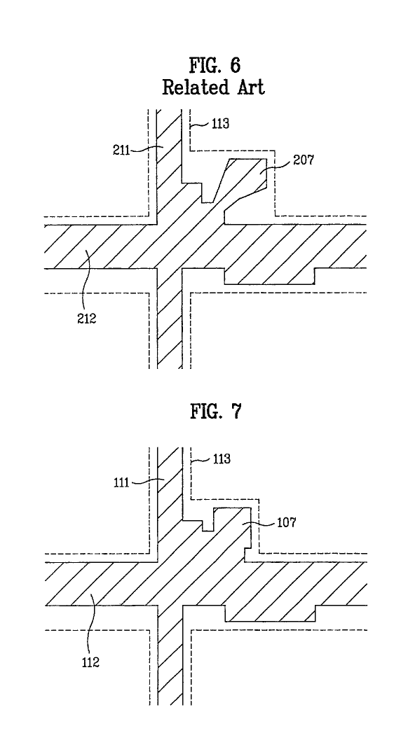

FIG. 6 illustrates a part of a unit pixel of a related art LCD device to which light is not transmitted at the time of attaching the upper and lower substrates to each other.

FIG. 7 illustrates a part of a unit pixel of the LCD device according to the present invention to which light is not transmitted after attaching the upper and lower substrates to each other.

A black matrix 113 is formed at an opposite upper substrate to prevent light from being transmitted to the data lines, gate lines, and TFTs. At this time, as shown in FIGS. 6 and 7, in the related art LCD device, the drain electrode 107 electrically connected to the pixel electrode protrudes into the pixel region, so that even a peripheral space of the drain electrode 107 is covered with the black matrix 113, thereby lowering aperture ratio. On the other hand, in the LCD device according to the present invention, an area where the drain electrode 207 extends into the pixel region is reduced, so that an area of the black matrix layer is decreased corresponding to the reduced area of the drain electrode 207, thereby improving an aperture ratio.

As aforementioned, the LCD device and the method for fabricating the same according to the present invention have the following advantages.

That is, since an area of the drain electrode of the TFT extending into the pixel region is reduced, but the contact area of the drain electrode and the pixel electrode is enlarged, an area of the black matrix layer formed on the upper substrate to prevent light from being transmitted to the TFTs is also reduced, so that an aperture ratio of the LCD device is improved, thereby increasing brightness and efficiency of the back light.

It will be apparent to those skilled in the art than various modifications and variations can be made in the present invention. Thus, it is intended that the present invention covers the modifications and variations of this invention provided they come within the scope of the appended claims and their equivalents.

What is claimed is:

1. A liquid crystal display device provided with a plurality of gate lines, a plurality of data lines, and a plurality of TFTs, the gate lines crossing the data lines to define a pixel region and the TFTs being formed at crossing points of the gate and data lines, wherein a contact hole that electrically connects a drain electrode of the TFTs with a pixel electrode of the pixel region is formed over predetermined portions of the drain electrode and the pixel region.

2. The liquid crystal display device as claimed in claim 1, wherein the TFTs and the pixel region comprises:
a gate electrode formed on an insulating substrate;
a gate insulating film formed on an entire surface of the insulating substrate including the gate electrode;
a semiconductor layer and an ohmic contact layer sequentially deposited at a predetermined portion on the gate insulating film;
source and drain electrodes formed right and left on the ohmic contact layer;
a passivation film formed on the entire surface of the substrate including the source and drain electrodes;
a contact hole formed by etching the passivation film to expose a predetermined portion of the drain electrode and a predetermined portion of the insulating substrate, where a pixel electrode will be formed later; and
the pixel electrode formed on the passivation film and the contact hole.

3. A liquid crystal display device comprising:
gate lines arranged to cross data lines on a substrate, thereby defining a pixel region;
thin film transistors, each having a gate electrode and source and drain electrodes, formed at crossing points of the gate lines and the data lines;
a contact hole formed over the drain electrode and the pixel region; and
a pixel electrode formed in the pixel region for connecting the pixel electrode to the drain electrode through the contact hole.

4. The liquid crystal display device as claimed in claim 3, wherein the contact hole is formed over an edge part of the drain electrode and the pixel region adjacent to the edge part of the drain electrode.

5. The liquid crystal display device as claimed in claim 3, wherein the each thin film transistor further comprises:
a substrate on which the gate electrode is located;
a gate insulating film on an entire surface of the substrate including the gate electrode;
a semiconductor layer on the gate insulating film above the gate electrode;
the source and drain electrodes located at opposite sides of the semiconductor layer; and
a passivation film formed on the entire surface of the substrate including the source and drain electrodes.

6. The liquid crystal display device as claimed in claim 5, wherein the contact hole is formed through passivation film on an edge part of the drain electrode and in the pixel region adjacent to the edge part of the drain electrode.

7. The liquid crystal display device as claimed in claim 5, wherein the contact hole is formed through the passivation film and the gate insulating film on an edge part of the drain electrode and in the pixel region adjacent to the edge part of the drain electrode.

8. A method for fabricating the liquid crystal display device comprising:
forming thin film transistors each having a gate electrode, a source electrode and a drain on an insulating substrate;
forming a passivation film on an entire surface of the substrate including the thin film transistors;
forming a contact hole over a predetermined portion of the drain electrode and a pixel region adjacent to the drain electrode; and
forming a pixel electrode in the pixel region connected to the drain electrode through the contact hole.

9. The method as claimed in claim 8, wherein the contact hole is formed over an edge part of the drain electrode and the pixel region adjacent to the edge part of the drain electrode.

10. The method as claimed in claim 8, wherein the contact hole is formed by selectively removing the passivation film on an edge part of the drain electrode and the pixel region adjacent to the edge part of the drain electrode.

11. The method as claimed in claim 8, wherein forming the thin film transistors comprises:
forming the gate electrode on the insulating substrate;
forming a gate insulating film on the entire surface of the insulating substrate including the gate electrode;
forming a semiconductor layer at a predetermined portion on the gate insulating film; and
respectively forming source and drain electrodes at opposite sides of the semiconductor layer.

12. The method as claimed in claim 11, wherein the contact hole is formed by selectively removing the passivation film and the gate insulating film on an edge part of the drain electrode and the pixel region adjacent to the edge part of the drain electrode.
